(19) United States
(12) Patent Application Publication
(10) Pub. No.: US 2014/0324257 A1
(43) Pub. Date: Oct. 30, 2014

(54) SYSTEM AND METHOD FOR CONTROLLING THE TRANSMISSION OF HIGH VOLTAGE CURRENT TO AN ELECTRIC MOTOR IN AN ELECTRIC VEHICLE

(71) Applicant: Matthew J. Dawson, Troy, MI (US)

(72) Inventor: Matthew J. Dawson, Troy, MI (US)

(21) Appl. No.: 13/937,426

(22) Filed: Jul. 9, 2013

Related U.S. Application Data
(60) Provisional application No. 61/670,212, filed on Jul. 11, 2012.

(51) Int. Cl. B60L 15/00

(52) U.S. Cl. CPC B60L 15/00
USPC 701/22

(57) ABSTRACT

A system for controlling the transmission of high voltage current to an electric motor in an electric vehicle having a torque control module which controls high voltage power to the electric motor and a powertrain control module. The powertrain control module is connected to the torque control module via a low voltage enabling electrical conduit and a high voltage enabling electrical conduit. The low voltage enabling electrical conduit controls the transmission of low voltage power to the torque control module. The high voltage enabling electrical conduit directly controls a switch that controls the transmission of high voltage power from the torque control module to the electric motor. Assertion of the high voltage enabling electrical conduit closes the switch to permit the flow of high voltage power from the torque control module to the electric motor. Non-assertion of the high voltage enabling electrical conduit opens the switch to prevent the flow of high voltage power from the torque control module to the electric motor.

### CROSS-REFERENCE TO RELATED APPLICATIONS

This application claims the benefit of U.S. Provisional Application No. 61/670,212 filed Jul. 11, 2012. The entire disclosure of the above application is incorporated herein by reference.

### FIELD

The present disclosure relates generally to control systems that permit the disabling of an electric motor in electric vehicles and, more particularly, to such control systems that prevent unintended acceleration of the vehicle.

### BACKGROUND

This section provides background information related to the present disclosure which is not necessarily prior act.

Electric vehicles show great promise for reducing the emissions of certain types of pollutants and for reducing the world's dependence on oil. However, to be accepted these vehicles must include many of the safety systems that are present in today's gasoline-powered vehicles, as well as other safety systems that may be beneficial. For example, many of today's gasoline-powered vehicles include systems for ensuring unintended acceleration.

It would be beneficial to provide control systems for the purpose of preventing unintended acceleration and which permit the disabling of the electric motor in electric vehicles.

### SUMMARY

This section provides a general summary of the disclosure, and is not intended to be a comprehensive disclosure of its full scope or all of its features.

In accordance with an aspect of the present disclosure, a control system is provided for controlling the transmission of high voltage current to an electric motor in an electric vehicle. The control system comprises a torque control module which controls high voltage power to the electric motor and a powertrain control module. For the purposes of this disclosure, an electric vehicle may be considered to be any type of vehicle that has one or more wheels that are driven by an electric motor. This includes, for example, electric vehicles that have only a battery pack for providing power, and for example, series and parallel hybrid vehicles that have an electric motor, a battery pack and an internal combustion engine that either provides power or is used solely to charge the battery pack.

In accordance with this and other aspects of the present disclosure, the powertrain control module is connected to the torque control module via a low voltage enabling electrical conduit and a high voltage enabling electrical conduit. The low voltage enabling electrical conduit controls the transmission of low voltage power to the torque control module. The high voltage enabling electrical conduit directly controls a switch that controls the transmission of high voltage power from the torque control module to the electric motor. Assertion of the high voltage enabling electrical conduit closes the switch to permit the flow of high voltage power from the torque control module to the electric motor. Non-assertion of the high voltage enabling electrical conduit opens the switch to prevent the flow of high voltage power from the torque control module to the electric motor. The powertrain control module is programmed to ensure non-assertion of the high voltage enabling electrical conduit during operation of the vehicle in the event of determining that any one of a plurality of selected types of fault has been generated.

In a particular embodiment of the present disclosure, the powertrain control module is programmed to: send a wake-up signal from the powertrain control module to the torque control module via the low voltage enabling electrical conduit, wherein the wake-up signal permits low voltage power to be received by the torque control module; assert the high voltage enabling electrical conduit between the powertrain control module and the torque control module in response to receiving a handshaking signal from the torque control module to the powertrain control module acknowledging the wake-up signal; reassert the high voltage enabling electrical conduit so that the high voltage enabling electrical conduit is non-asserted in response to the assertion acknowledgment signal, in response to receiving an assertion acknowledgment signal from the torque control module to the powertrain control module indicating acknowledgment of the assertion; and reassert the high voltage enabling electrical conduit in response to receiving a deassertion acknowledgment signal from the torque control module to the powertrain control module indicating acknowledgment of the deassertion.

Additionally or alternatively to the programming described above, the powertrain control module may be further programmed to: issue a torque command to the torque control module; determine an expected acceleration for the vehicle based on the issued torque command; determine an actual acceleration for the vehicle based on signals from at least one sensor; determine whether the actual and expected accelerations differ by more than a selected amount; and generate one of the selected types of fault.

In another aspect, the present disclosure is directed to a method of controlling the transmission of high voltage current to an electric motor in an electric vehicle, the method comprising the steps of:

a) providing a torque control module which controls high voltage power to the electric motor;

b) providing a powertrain control module which is connected to the torque control module via a low voltage enabling electrical conduit and a high voltage enabling electrical conduit, wherein the low-voltage enabling electrical conduit controls the transmission of low voltage power to the torque control module, and wherein the high voltage enabling electrical conduit directly controls a switch that controls the transmission of high voltage power from the torque control module to the electric motor, wherein assertion of the high voltage enabling electrical conduit closes the switch to permit the flow of high voltage power from the torque control module to the electric motor and non-assertion of the high voltage enabling electrical conduit opens the switch to prevent the flow of high voltage power from the torque control module to the electric motor;

c) sending a wake-up signal from the powertrain control module to the torque control module via the low voltage enabling electrical conduit, wherein the wake-up signal permits low voltage power to be received by the torque control module;

d) sending a handshaking signal from the torque control module to the powertrain control module in response to the wake-up signal;

e) asserting the high voltage enabling electrical conduit between the powertrain control module and the torque control module;

f) sending an assertion acknowledgment signal from the torque control module to the powertrain control module indicating acknowledgment of the assertion;

g) deasserting the high voltage enabling electrical conduit so that the high voltage enabling electrical conduit is non-asserted, in response to the assertion acknowledgment signal;

h) sending a deassertion acknowledgment signal from the torque control module to the powertrain control module; and

i) reasserting the high voltage enabling electrical conduit in response to the deassertion acknowledgment signal.

Further areas of applicability will become apparent from the description provided herein. The description and the specific examples in this summary are intended for purposes of illustration only and are not intended to limit the scope of the present disclosure.

### BRIEF DESCRIPTION OF THE DRAWINGS

The present invention will now be described by way of example only with reference to the attached drawings, in which:

FIG. 1 is a side view of an exemplary vehicle with an electric traction motor and a control system in accordance with an embodiment of the present disclosure;

FIG. 2 is a schematic illustration of an electrical system for the vehicle shown in FIG. 1;

FIG. 3 is a schematic illustration of a torque control module that makes up part of the electrical system shown in FIG. 2; and

FIG. 4 illustrates a method of controlling the transmission of high voltage current to the electric traction motor in the vehicle shown in FIG. 1.

### DETAILED DESCRIPTION

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

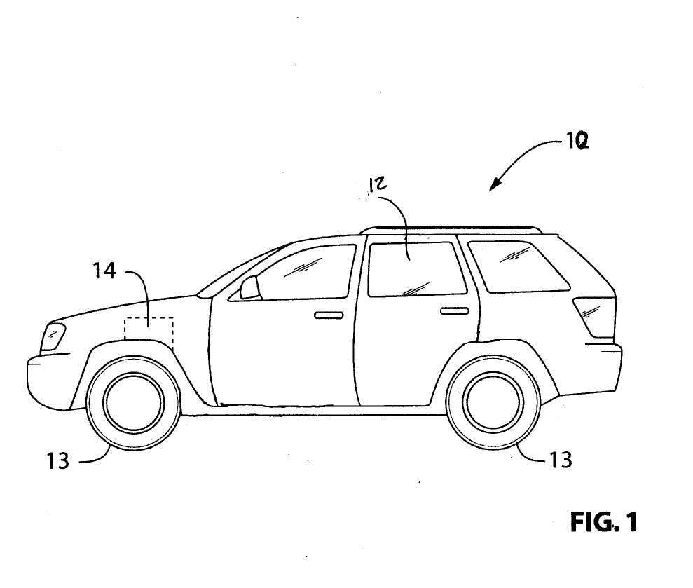

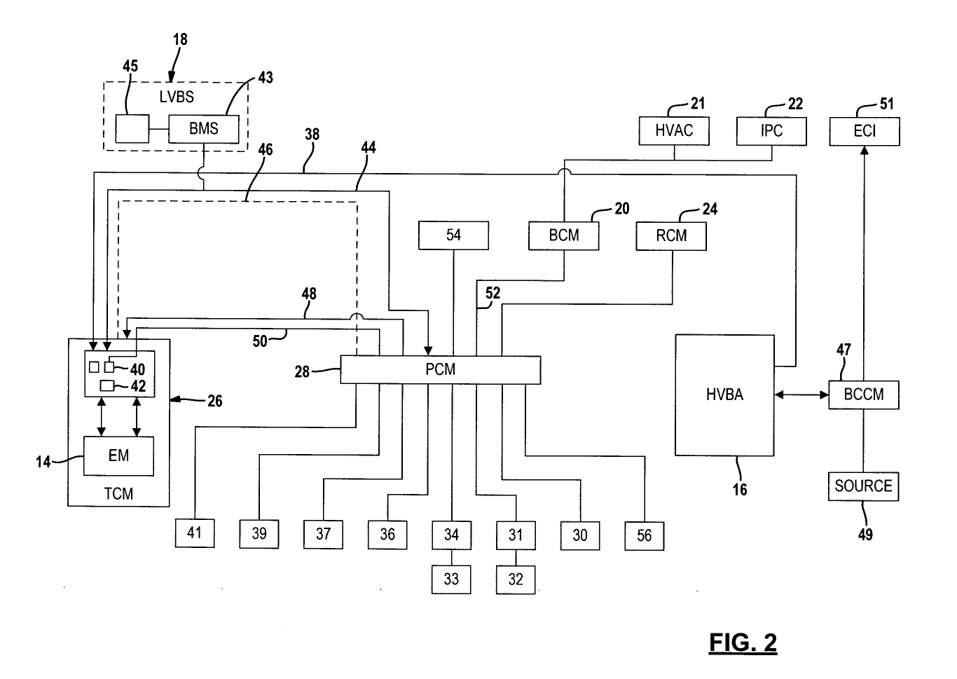

Reference is made to FIG. 1, which shows an electric vehicle 10 in accordance with an exemplary embodiment of the present invention. The vehicle 10 includes a vehicle body 12, a plurality of wheels 13 and an electric motor 14 for driving one or more of the wheels 13. Optionally, the vehicle 10 may include a plurality of electric motors 14 for driving a plurality of wheels 13. Referring to FIG. 2, the vehicle 10 further includes a high voltage battery system or assembly (HVBA) 16 for providing power to the electric motor (EM) 14, a low voltage battery system or assembly (LVBA) 18 for providing power to other vehicle components, and a plurality of controllers for controlling various vehicle components. The controllers may include, for example, a body control module (BCM) 20 for controlling components such as the HVAC controls 21, the instrument panel cluster (IPC) 22 and other components, a restraints control system or module (RCM) 24 for controlling components such as the airbags (not shown), a torque control module (TCM) 26 for controlling the transmission of high voltage current to the electric motor 14, and a powertrain control module (PCM) 28 for controlling the operation of the torque control module 26. The vehicle 10 further includes a plurality of sensors and sensing systems for providing data to the controllers, including, for example, a gear selection sensing system 30, an accelerator pedal position sensing system 31 for sensing the position of the accelerator pedal 32, a brake pedal sensing system 34 for sensing the position of a brake pedal 33, a high voltage battery system temperature sensor 36 for determining the temperature of the high voltage battery system 16, a powertrain temperature sensor 37 for determining the temperature of the electric motor 14 and related components, an ambient air temperature sensor 39, and a plurality of crash sensors 41 for detecting signs of an impending crash, such as, for example, deceleration sensors. Each of the exemplary sensing systems noted above could include one or more individual sensors. Low voltage battery system 18 is shown to include a battery monitoring unit 43 and a low voltage (12 v) vehicle battery 45. A battery charge control module (BCCM) 47 controls charging of vehicle 10 from an external source 49 and provides the vehicle operator with a state of charge (SOC) indication via an external charge indicator (ECI) 51.

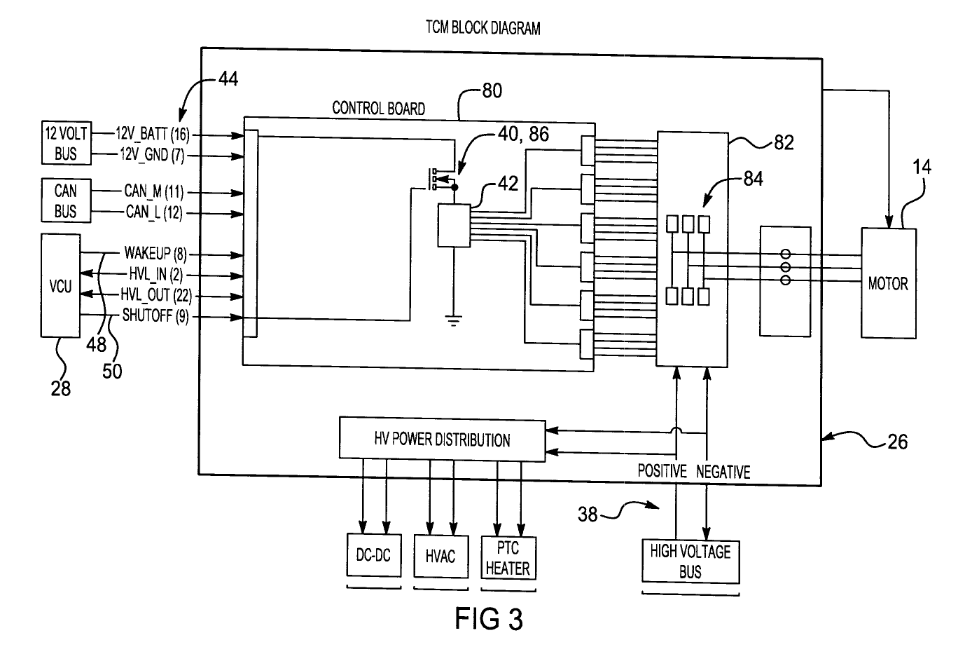

A high voltage electrical conduit 38 transmits high voltage current from the high voltage battery system 16 to the torque control module 26. The torque control module 26 (FIG. 3) includes a control board 80, an IGBT module 82 which contains six IGBT's 84 that convert high voltage DC power from the high voltage bus 38 and send this current to the electric motor 14, a gate drive module 42, and a switch 40. The gate drive module 42 controls the operation of the IGBT's 84. The gate drive module 42 requires power (e.g. low-voltage power) to operate. The switch 40, which may be a MOSFET 86, for example, controls the current flow to the gate drive module 42. It is preferable for any conduits and components carrying high voltage current to be well separated from the control board and generally from other conduits and components carrying low voltage current so as to inhibit any interference caused thereby.

A low voltage electrical conduit 44 transmits low voltage current from the low voltage battery system 18 to the torque control module 26 and to the powertrain control module 28.

A communication bus 46 (e.g. a CAN bus) permits the transmission of commands and data between the powertrain control module 28 and the torque control module 26.

A low voltage enabling electrical conduit 48 is provided between the powertrain control module 28 and the torque control module 26. The conduit 48 provides a digital input to the torque control module 26 that controls whether or not low voltage current can be sent to the torque control module 26 from the low voltage battery system 18 via conduit 44, so as to provide power for the operation of the torque control module 26. When the powertrain control module 28 asserts the low voltage enabling electrical conduit 48, low voltage current can be sent to the torque control module 26, and may be sent to the torque control module 26 barring some other reason, such as a fault somewhere that prevents it. When the conduit 48 is not asserted, low voltage current is not sent to the torque control module 26. The low voltage enabling electrical conduit 48 may be a dedicated line whose sole purpose is to enable or disable low voltage current transmission to the torque control module 26.

A high voltage enabling electrical conduit 50 is also provided between the powertrain control module 28 and the torque control module 26. The conduit 50 is connected to the switch 40 that controls whether or not high voltage current can be sent to the gate drive module 42. In an exemplary embodiment shown in FIG. 3, the conduit 50 is connected to the gate of the MOSFET 86. When the conduit 50 is asserted, current can flow to the gate drive module 42. When the conduit 50 is not asserted, current is prevented from flowing to the gate drive module 42, thereby disabling the gate drive module 42 and preventing control of the IGBT's 84 and thereby preventing operation of the electric motor 14. The high voltage enabling electrical conduit 50 is a dedicated line whose sole purpose is to control the state of the switch 40.

The powertrain control module 28 receives low voltage current from the low voltage battery system 18 via the low voltage electrical conduit 44. The powertrain control module 28 receives a digital input from the body control module 20 via a low voltage enabling conduit 52, which controls the operational state of the powertrain control module 28. Other than the operation of the torque control module 26, the powertrain control module 28 may also control the operation of components such as the DC-DC converter, shown at 54.

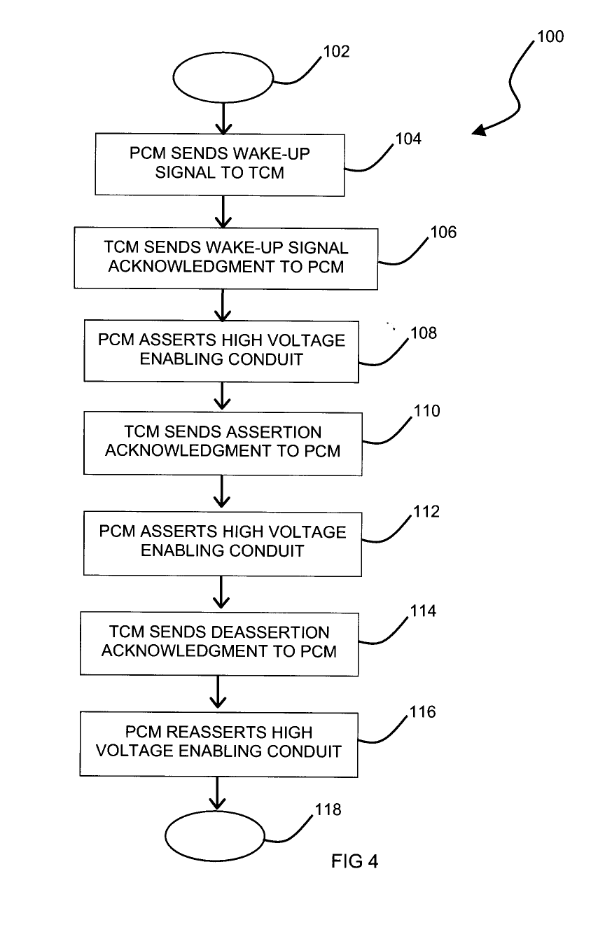

During startup of the vehicle 10, the body control module 20 enables low voltage current to be sent to the powertrain control module 28 to begin an initial sequence of operations in the powertrain control module 28. At some point in the initial sequence, a series of actions take place between the powertrain control module 28 and the torque control module 26, which are used to assess the integrity of the high voltage enabling conduit 50 so as to ensure that the conduit 50 is available to cut power to the motor 14 in a situation where it is needed (e.g. when an impending crash is detected). This series of actions is shown as a method 100 illustrated in FIG. 4. The method begins at 102. At step 104, the powertrain control module 28 sends a wake-up signal to the torque control module 26 over the low voltage enabling conduit 48 enabling low voltage current to be sent to the torque control module 26. At step 106, the torque control module 26, in response to receiving low voltage power, begins its own startup sequence of operations, one of which is to send a signal back to the powertrain control module 28 over the CAN bus 46 acknowledging receipt of the wake-up signal. The signal sent back to the powertrain control module 28 may be referred to as a wake-up signal acknowledgment signal. At step 108, the powertrain control module 28, in response to receiving the wake-up signal acknowledgment signal, asserts the high voltage enabling electrical conduit 50. At step 110, the torque control module 26 sends an assertion acknowledgment signal back to the powertrain control module 28 over the CAN bus 46 indicating acknowledgment of the assertion. At step 112, the powertrain control module 28 deasserts the high voltage enabling electrical conduit 50 so that the high voltage enabling electrical conduit 50 is non-asserted, in response to receiving the assertion acknowledgment signal. At step 114, the torque control module 26 sends a deassertion acknowledgment signal to the powertrain control module 28 over the CAN bus 46. At step 116, the powertrain control module 28 reasserts the high voltage enabling electrical conduit 50 in response to receiving the deassertion acknowledgment signal because at this point, the powertrain control module 28 has verified that the torque control module 26 can detect assertion of the conduit 50 and, perhaps more importantly, can detect deassertion of the conduit 50. At that point, the powertrain control module 28 leaves the conduit 50 asserted for that drive cycle, unless it must deassert the conduit 50 for some reason, such as a certain type of fault or, for example, due to a sensed impending crash. The method 100 ends at 118.

If the powertrain control module 28 does not receive any one of the acknowledgment signals that it is expecting when carrying out the method 100, then a fault is generated that causes the powertrain control module 28 to ensure non-assertion of the high voltage enabling electrical conduit 50. Ensuring non-assertion of the high voltage enabling electrical conduit 50 may be by actual deassertion of the conduit 50 if it was asserted, or simply by determining that it is already non-asserted and therefore does not require deassertion.

In the method 100, all the communication signals from the torque control module 26 to the powertrain control module 28 have been described as being sent via the CAN bus 46. It will be understood that it is possible for these signals to be sent over some other bus, or some other communication means. In an embodiment, one or more of the signals may be sent over a first communication means, and one or more may be sent over a second communication means. The entirety of the communications means used for communication between the powertrain control module 28 and torque control module 26 (aside from the conduits 48 and 50) may be referred to as a communication bus.

While the torque control module 26 and the powertrain control module 28 are programmed to carry out the steps of the method 100, it will be understood that the torque control module 26 and the powertrain control module 28 may perform other checks and may additionally be programmed to respond differently than described above under certain conditions. For example, if a fault occurs in the high voltage battery system 16 during the carrying out of the method 100 the powertrain control module 28 may be programmed to keep the high voltage enabling electrical conduit 50 non-asserted, regardless of where it was in carrying out the method 100.

The embodiment of the system described above is advantageous in terms of safety, because it provides a dedicated hardware line (i.e. conduit 50) between the powertrain control module 28 and the torque control module 26 that is directly operatively connected to the switch 40. Thus, the conduit 50 does not carry a signal to a microprocessor which interprets the signal and then acts upon the signal to open the switch 40. Such an arrangement could lead to an error in the sense that the microprocessor could, for some reason, not act to open the switch 40 even though it received a signal from the powertrain control module 28 requesting it. Instead, by having the direct connection to the switch 40, there are relatively fewer problems that can occur to prevent the torque control module 26 from detecting when the powertrain control module 28 deasserts the conduit 50. Furthermore, by verifying that the torque control module 26 can detect assertion and, in particular, deassertion of the conduit 50 on startup, the likelihood of failure of the torque control module 26 in detecting the deassertion should it occur during use of the vehicle 10 is reduced.

During use of the vehicle, the powertrain control module 28 issues torque commands to the torque control module 26 based on, among other things, the input from the vehicle driver via the accelerator pedal 32. These torque commands may be sent over the CAN bus 46. The torque control module 26 controls the current to the electric motor 14 to achieve the drive torque requested by the powertrain control module 28. The powertrain control module 28 may optionally perform a check to determine whether the vehicle's behaviour is as expected based on the torque command issued to the torque control module 26. For example, the powertrain control module 28 may calculate that the torque command should result in a certain expected acceleration for the vehicle 10. The powertrain control module 28 compares the expected acceleration to the actual acceleration (measured via sensors, such as wheel rotation sensors shown at 56), and determines if the two match closely enough. If the measured and expected accelerations do not match closely enough (and particularly if the measured acceleration exceeds the expected acceleration by more than a selected amount) a fault is generated and the powertrain control module 28 may be programmed to respond to the fault by deasserting the high voltage enabling electrical conduit 50 so that power to the electric motor 14 is cut.

It is important to reduce the potential for actuation of the electric motor 14 when the powertrain control module 28 has determined that the electric motor 14 should not be actuated. The system and method described herein reduce that potential by providing a simple hardware connection to permit disabling the transmission of high voltage current to the electric motor 14, and by verifying the successful operation of that hardware connection on vehicle startup.

Throughout this disclosure the term low voltage current and high voltage current have been used to denote current coming from the low voltage and high voltage battery systems 18 and 16. The voltage of the low voltage current may be any suitable voltage, such as, for example, about 12 volts. The voltage of the high voltage current may be any suitable voltage, such as, for example, about 400 volts.

While the above description constitutes a plurality of embodiments of the present invention, it will be appreciated that the present invention is susceptible to further modification and change without departing from the fair meaning of the accompanying claims.

1. A method of controlling the transmission of high voltage current to an electric motor in an electric vehicle, the method comprising the steps of:
a) providing a torque control module which controls high voltage power to the electric motor;
b) providing a powertrain control module which is connected to the torque control module via a low voltage enabling electrical conduit and via a high voltage enabling electrical conduit, wherein the low-voltage enabling electrical conduit controls the transmission of low voltage power to the torque control module, and wherein the high voltage enabling electrical conduit directly controls a switch that controls the transmission of high voltage power from the torque control module to the electric motor, wherein assertion of the high voltage enabling electrical conduit closes the switch to permit the flow of high voltage power from the torque control module to the electric motor and non-assertion of the high voltage enabling electrical conduit opens the switch to prevent the flow of high voltage power from the torque control module to the electric motor;
c) sending a wake-up signal from the powertrain control module to the torque control module via the low voltage enabling electrical conduit, wherein the wake-up signal permits low voltage power to be received by the torque control module;
d) sending a handshaking signal from the torque control module to the powertrain control module in response to the wake-up signal;
e) asserting the high voltage enabling electrical conduit between the powertrain control module and the torque control module;
f) sending an assertion acknowledgment signal from the torque control module to the powertrain control module indicating acknowledgment of the assertion;
g) deasserting the high voltage enabling electrical conduit so that the high voltage enabling electrical conduit is non-asserted, in response to the assertion acknowledgment signal;
h) sending a deassertion acknowledgment signal from the torque control module to the powertrain control module; and
i) reasserting the high voltage enabling electrical conduit in response to the deassertion acknowledgment signal.

2. The method of claim 1, wherein the powertrain control module is connected to the torque control module via a communication bus, wherein the handshaking signal, the assertion acknowledgment signal and the deassertion acknowledgment signal are all transmitted to the powertrain control module via the communication bus.

3. The method of claim 1, wherein the high voltage enabling electrical conduit is used solely by the powertrain control module for assertion and deassertion for controlling the state of the switch.

4. The method of claim 1 further comprising the steps of:
j) issuing a torque command to the torque control module after step i);
k) determining an expected acceleration for the vehicle based on the issued torque command;
l) determining an actual acceleration for the vehicle based on signals from at least one sensor;
m) determining whether the actual and expected accelerations differ by more than a selected amount; and
n) ensuring non-assertion of the high voltage enabling electrical conduit based on the result of step m).

5. A system for controlling the transmission of high voltage current to an electric motor in an electric vehicle, the system comprising:
a torque control module which controls high voltage power to the electric motor; and
a powertrain control module which is connected to the torque control module via a low voltage enabling electrical conduit and via a high voltage enabling electrical conduit, wherein the low voltage enabling electrical conduit controls the transmission of low voltage power to the torque control module, and wherein the high voltage enabling electrical conduit directly controls a switch that controls the transmission of high voltage power from the torque control module to the electric motor, wherein assertion of the high voltage enabling electrical conduit closes the switch to permit the flow of high voltage power from the torque control module to the electric motor and non-assertion of the high voltage enabling electrical conduit opens the switch to prevent the flow of high voltage power from the torque control module to the electric motor,
wherein the powertrain control module is programmed to ensure non-assertion of the high voltage enabling electrical conduit during operation of the vehicle in the event of determining that any one of a plurality of selected types of fault has been generated.

6. The system of claim 5, wherein the powertrain control module is further programmed to:
a) send a wake-up signal from the powertrain control module to the torque control module via the low voltage enabling electrical conduit, wherein the wake-up signal permits low voltage power to be received by the torque control module;
b) assert the high voltage enabling electrical conduit between the powertrain control module and the torque control module, in response to receiving a handshaking signal from the torque control module to the powertrain control module acknowledging the wake-up signal;
c) deassert the high voltage enabling electrical conduit so that the high voltage enabling electrical conduit is non-asserted, in response to the assertion acknowledgment signal, in response to receiving an assertion acknowledgment signal from the torque control module to the powertrain control module indicating acknowledgment of the assertion; and
d) reassert the high voltage enabling electrical conduit in response to receiving a deassertion acknowledgment signal from the torque control module to the powertrain control module indicating acknowledgment of the deassertion.

7. The system of claim 5, wherein the powertrain control module is connected to the torque control module via a communication bus, wherein the handshaking signal, the assertion acknowledgment signal and the deassertion acknowledgment signal are all transmitted to the powertrain control module via the communication bus.

8. The system of claim 5, wherein the high voltage enabling electrical conduit is used solely by the powertrain control module for assertion and deassertion for controlling the state of the switch.

9. The system of claim 5, wherein the powertrain control module is further programmed to:
e) issue a torque command to the torque control module;
f) determine an expected acceleration for the vehicle based on the issued torque command;
g) determine an actual acceleration for the vehicle based on signals from at least one sensor;
h) determine whether the actual and expected accelerations differ by more than a selected amount; and
i) generate one of the selected types of fault depending on the result of step h).

10. A vehicle comprising:
a pair of wheels;
an electric motor mechanically connected to the pair of wheels for providing tractive power thereto;
a torque control module which controls high voltage power to the electric motor; and
a powertrain control module which is connected to the torque control module via a low voltage enabling electrical conduit and via a high voltage enabling electrical conduit, wherein the low voltage enabling electrical conduit controls the transmission of low voltage power to the torque control module, and wherein the high voltage enabling electrical conduit directly controls a switch that controls the transmission of high voltage power from the torque control module to the electric motor, wherein assertion of the high voltage enabling electrical conduit closes the switch to permit the flow of high voltage power from the torque control module to the electric motor and non-assertion of the high voltage enabling electrical conduit opens the switch to prevent the flow of high voltage power from the torque control module to the electric motor,
wherein the powertrain control module is programmed to ensure non-assertion of the high voltage enabling electrical conduit during operation of the vehicle in the event of determining that any one of a plurality of selected types of fault has been generated.

11. The vehicle of claim 10 wherein the powertrain control module is programmed to: send a wake-up signal from the powertrain control module to the torque control module via the low voltage enabling electrical conduit, wherein the wake-up signal permits low voltage power to be received by the torque control module; assert the high voltage enabling electrical conduit between the powertrain control module and the torque control module, in response to receiving a handshaking signal from the torque control module to the powertrain control module acknowledging the wake-up signal; deassert the high voltage enabling electrical conduit so that the high voltage enabling electrical conduit is non-asserted, in response to the assertion acknowledgment signal, in response to receiving an assertion acknowledgment signal from the torque control module to the powertrain control module indicating acknowledgment of the assertion; and reassert the high voltage enabling electrical conduit in response to receiving a deassertion acknowledgment signal from the torque control module to the powertrain control module indicating acknowledgment of the deassertion.

12. The vehicle of claim 10, wherein the powertrain control module is connected to the torque control module via a communication bus, wherein the handshaking signal, the assertion acknowledgment signal and the deassertion acknowledgment signal are all transmitted to the powertrain control module via the communication bus.

13. The vehicle of claim 10, wherein the high voltage enabling electrical conduit is used solely by the powertrain control module for assertion and deassertion for controlling the state of the switch.

14. The vehicle of claim 10, wherein the powertrain control module is programmed to: issue a torque command to the torque control module; determine an expected acceleration for the vehicle based on the issued torque command; determine an actual acceleration for the vehicle based on signals from at least one sensor; determine whether the actual and expected accelerations differed by more than a selected amount; and generate one of the selected types of fault depending on whether the selected amount has been exceeded.
